(19) United States
(12) Patent Application Publication
(10) Pub. No.: US 2017/0243457 A1
(43) Pub. Date: Aug. 24, 2017

(54) FALL PROTECTION FOR LOW SLOPE ROOFERS USING RADIO WAVES

(71) Applicant: Jon Milbrand, Washington, MI (US)

(72) Inventor: JON MILBRAND, Washington, MI (US)

(21) Appl. No.: 15/050,849

(22) Filed: Feb. 23, 2016

(51) Int. Cl. G08B 21/02; G08B 3/10

(52) U.S. Cl. CPC G08B 21/02; G08B 3/10; H04M 1/72536

(57) ABSTRACT

The invention through its personal protective equipment (PPE) may warn the roof worker when that roofer moves beyond the setback selected from the exposed unprotected roofs edge, beyond which a fall causing injury or a fatality may occur. The PPE monitors each worker, keeping them back from the roofs edge according to OSHA fall standard 19260501b10. The transmitter keeps a log of the date and time incursions occur beyond the selected setback for each workers' PPE. This information is stored in a transmitter and downloaded via a smart phone APP created and coded by this new art and sent to management, insurer, and OSHA for safety compliance and production monitoring. The hardhat PPE offers additional safety protection.

### BACKGROUND OF THE INVENTION

The formation of OSHA in 1970 has everything to do with the present art for fall protection for low slope roofers. In 1980, OSHA put forth the first set of rules designed to keep low slope roofers safe from falls. It allowed four choices for fall protection. As this rule was issued as a standard it was the only option allowed for fall protection, absent asking OSHA for an exception known as a variance. The variance process is an arduous one that has a history of OSHA granting very few variance requests, less than 5%. By default therefore, all low slope roofing contractors had to select from four products and the seven methods involving those four products to achieve compliance with the standard for fall protection.

On Aug. 9, 1994, a new standard was enacted and put into effect for February 1995. It was in essence a re-write of the 1980 standard with more performance based language. The fall protection for low slope roofers was standard 19260501b10. It offers the same choices of four products along with seven methods for compliance. Again, without an approved variance these are the only choices allowed. It must be stated that the possible inclusion of other products was looked at by the enactors of the new law but for various reasons the choices remained the same. The current standard is still in effect today. The standard is over 35 years old.

It one were to read all 394 pages of the standard, one would say that the thoroughness of the research and effort cannot be questioned. As far as this particular standard, the analysis was OSHA proposed to continue its existing requirements but to seek public comment on other methods of protecting workers from fall hazards at the edge of low-sloped roofs (flat roofs) during roofing work.

The four product choices in 1980 and 1995 were the following: guardrails, personal fall arrest systems (safety harnesses with motion stopping lanyards), safety nets and warning lines. These were to be used when low slope roofing work was being done six and ten foot back from the roof's unprotected edge. The first three of the choices are considered motion stopping safety (MSS) devices. They have been discounted as a universal fall protection choice for low-slope roofing for specific reasons stated in the Federal Registry when the 1994 standard was announced.

The shortcomings of the three MSS devices are basically the reason for inclusion of warning lines as the fourth option. Guardrails were dismissed as being not a near universal choice because the guardrails had to be removed when the roof was to be installed in that area by the low-slope roofers. The removal caused a safety gap for that period of time when the removal occurred and increased the risk of falls when the guardrails were removed or absent.

The safety nets were excluded as a near universal choice because the ability of existing buildings to be compatible with the installation of eight to ten foot wide safety nets was not a high percentage of the existing inventory of low sloped buildings. So it was not universal due to functionality (not mentioned was cost which was the highest of all the options).

The personal fall arrest systems were excluded as a near universal solution because personal fall arrest systems often become tangled or pose serious trip and fall hazards. So this option when working with a crew of low slope roofers posed other safety hazards that OSHA felt outweighed its benefit of the fall protection option offered.

This left warning lines as the only near universal option. Due to its low cost, it appears it is the default/universal choice among the four options. OSHA believes that the difficulties with conventional guarding systems (referred to in the standard as “motion-stopping safety (MSS) systems”) during the performance of built-up roofing work, may be avoided by allowing the use of a warning line and/or safety monitoring system. This was so stated in the 1994 standard published in the Federal Registry.

In summary, the other three choices have serious safety deficiencies: a safety gap due to removal, impractical to install on a large percentage of buildings, and pose their own safety hazards when used. The warning lines were included as the fourth choice and the near universal one.

The critics felt warning lines had their deficiencies also. The national roofing union commented in 1985 stating “the standard has been in effect now for over six years yet the industry continues to be plagued by the same safety problems—roof falls. Although there is no statistical evidence to demonstrate the effectiveness of the standard one way or the other, workmen's compensation rates for the roofing industry have risen significantly over the past six years. That indicates among other things that little is being done in the roofing industry to reduce the incidence of injuries and deaths. In 1979, we endorsed OSHA's proposed rule to provide for a warning line on low-pitched roofs primarily because there were no standards covering the guarding of low-pitched roofs and something had to be done immediately. We also stated that we would press for total perimeter protection if the warning line approach did not prevent injuries or deaths from falls off the roof edge.”

Other research of OSHA's statistics indicates that warning lines for fall standard 19260501b10 are not effective due to its not being used. It has been criticized as cumbersome and an impairment to production as the reason for its disuse. It has not been successful in reducing the fatality rate despite significant enforcement effort by OSHA.

The prior art shows the sparsity of innovation in the safety field of fall protection or prevention. Roof work traditionally is a dangerous occupation or undertaking. The height combined with the normally unprotected roofs edge invite falls to the people installing new roof installation and is the risk that every low slope roofer is faced with. The preoccupation with the ongoing work, combined with momentarily forgetting where one is in relation to the edge of the roof is often the cause of falls. The risk is dealing with one hazard, a fall, in a defined area—the roof's unprotected edge.

The tradesman in this case, the roofer, has specific work to perform for an entire workday comprising more than eight hours, typically. The low slope roofer has to be mindful where he is at constantly, as the risk of not being cognizant is serious injury or a fatality, while simultaneously concentrating on the roof work at hand.

The prior art has attempted to track personnel and equipment in danger areas such as firemen fighting a conflagration on a large commercial building. It tags the people and equipment individually and then tracks them based on a feed from a navigational satellite supporting a GPS function. The tag then transmits its location to the reader which interfaces with the graphic display giving the site commander the location of all the men and equipment. Reliable functionality is a problem for the tags because often the ability of the tags to communicate with the satellite is compromised for a variety of reasons. Time delay and accuracy of the GPS function (3 to 5 feet) as well as cost are weaknesses of the system. The time to calculate and inform a worker is too long to prevent the worker from crossing that 6 or 10 foot fall danger zone and incurring a fall.

U.S. Pat. No. 5,552,772 discloses an emergency responder wearing a location device (LD) which receives electromagnetic signals that contain information allowing current determination of the present location of the LD unit and thus the location of the emergency responder from three or more signal sources.

U.S. Pat. No. 7,633,387 discloses a methodology for calibrating a tracking system of the type used by emergency responders at the scene of a chaotic event, such as a fire or the like. Prior art also dealt with confinement of an individual to a defined specific area similar to a low slope roof. The disadvantage of the prior art is the restriction to one individual. The one site location is not a disadvantage in relation to this application as it can represent one jobsite if it were a safety device preventing falls to low slope roofers. The range of the transponder is also a limiting factor.

U.S. patent RE 39,909 contains several improvements to the previous art of confinement. The main improvement is the plurality of individuals that can use this art simultaneously. The second improvement is that this art can also deliver a deterrent shock to the confined individuals to dissuade the confined individuals from leaving confined areas. The triangulation determining that the individual has left the confined space is similar to GPS as far as accuracy and time of recognition that a violation of prescribed boundaries has occurred. The accuracy of this art has too large of an error factor determining location to be considered for use as a fall protection for low slope roofers where the setbacks are six and ten foot, respectively. The calculation time to determine that a violation of confinement has occurred is too long and would allow the violator to move easily beyond the six or ten foot setback prescribed by OSHA in keeping with the requirements of standard 19260501b10 before being notified and/or shocked. There are many forms of perimeter alarms in the prior art. The basic design of the structural components for the many uses of perimeter alarms are similar despite the countless number of designs and the vast amount of objectives that can be required. Prior art includes U.S. Pat. Nos. 5,486,814; 5,619,187; 5,408,222; and DES 374,190.

The past prior art devices all contain a main sensor unit wearable by the user, which provides an alarm if the wearer breaks a boundary of the predefined area; a perimeter defining assembly for providing an indication of the boundary of the predefined area and a remote unit for receiving a signal from the main sensor unit that the boundary of the predefined area has been broken which provides an alarm for the monitoring person or firm.

U.S. Pat. No. 6,720,881 is representative of prior art in that the basic construction is replicated. This prior art provides a strobe and alarm as an auditory and visual marker when the wearer breeches the predefined perimeter.

Around or about the time of alarms there was prior art wherein gloves contained warning devices. The difference here the wearer of the gloves was the person sounding an alarm to alert other pedestrians, bicycles and cars to the presence of the person wearing the gloves who also was on a bicycle or rollerblades with the express purpose of collision avoidance. There were four U.S. Pat. Nos. 6,006,357; 6,112,330; 5,177,467 and 6,529,121 in this art.

U.S. Pat. No. 5,727,758 is prior art that uses radio waves (RF) to accomplish a warning of railroad personnel. A transmitter on a train that transmits a continuous warning signal on a set RF that announces the arrival of the incoming train.

U.S. Pat. No. 5,554,972 is an electronic perimeter warning system having a warning line. Submitted before the OSHA rule change with its more precise language called commercial roofing low sloped roofing, this prior art did not succeed in procuring a permanent variance for this product from OSHA. The fact that it is the only prior art in this specific field of fall protection for low slope roofers is noteworthy and reinforces the inadvertent inhibition of technological innovation that occurs due to the standards. Battery powered signal transmitters and receivers establish a signal beam between two locations. When the continuity of the beam is broken, an alarm is sounded to warn the person who is crossing the signal beam that they are in eminent danger of a fall from a low slope roof due to the workman's proximity to the unprotected edge of the low slope roof.

The background of this prior art's patent reiterates the problem with low slope roofing as related to roofers experiencing falls. This prior art indicates that “falls from roof edges occur in a variety of somewhat predictable circumstances”. Quantifying falls the prior art further states that “one recurring circumstance which give rise to roof top falls is that of the workman who inadvertently lose track of their proximity to a roof edge while working. They may stray towards a roof edge without being aware of it due to their concentration to the task at hand or due to the very manner in which they must move, including backing up as they carry out roofing tasks.” The prior art goes on to quantify falls further by saying “another recurring circumstance giving rise to roof top falls is when a workman is involved in the operation of a piece of roofing equipment. In such circumstances, a workman does not often see the area in front of the equipment or he may take his vision from the path along which he is traveling as he monitors the equipment. This may lead to the equipment moving over the edge of the roof leading to an unexpected event which also may place the operator of the equipment in danger of falling from the roof.” Once quantified the circumstances relating to roof falls this prior art discusses the OSHA standards for falls and the valid view of their shortcomings of the warning systems in the standard. “First the personal monitoring system rely upon human observation to warn workers of roof edge dangers. They are susceptible to failure by the mere fact that humans make mistakes. Second, the warning line systems are bulky in that they require a large number of upright stanchions, with heavy weighted bottoms, to surround the perimeter on a large commercial (low slope) roofing project. Thus a large amount of weight must be taken to the roof top and placed along a large perimeter. This is labor intensive and time consuming. In addition, such systems use a flexible line between stanchions, are prone to failure if the line is too slack or the workman does not sense the feel of the line or it is impacted by equipment which does not sense its presence.” For those reasons, there has evolved in low slope roofing “an environment which perimeter warning lines are not put in place when regulations (from OSHA) requires that they be used. As a result, the incidence of falls and injuries increases.” The prior art avoids this calamitous results by providing an inexpensive, effective and very portable electronic warning system with which to guard the perimeters of the roof while work is being undertaken.

The prior art while receiving a patent and an improvement over previous art was not approved by OSHA to be used. The main shortcoming of the prior art is that it did not take into consideration that there would be a significant number of incursion into the fall danger zone by the crew while work was ongoing. The alarm continually going off for all the crew to hear rendered its actuations or alarm ineffectual due to the repetition. If the alarm could be given individually to the offending party privately, this prior art would be more effective. The other shortcoming is the prior art does not differentiate between ingress and egress only that the beam is broken not how it was broken. Ingress breakage of the beam is not eminent danger whereas egress breakage is.

U.S. Pat. No. 3,753,421 discloses a signal emitting wire being used to define a restricted area and an animal wears a receiver in the form of a collar. When the animal nears the wire, the collar picks up the transmitted signal which triggers a circuit in the collar to give the animal an electric shock, causing the animal to abort the attempt of leaving the restricted area.

U.S. Pat. Nos. 4,733,633 and 4,745,882 disclose a second loop in conjunction with a single loop consisting of a transmitter and antenna wire defining the restrictive boundary.

Venczel's U.S. Pat. No. 4,766,847 discloses a two coil receiver to negate the additive signal strength at 90 degree corners of restrictive boundaries while Brose's U.S. Pat. No. 4,898,120 discloses a way to store the signal strength of boundaries, converted to a number in the receiver to be the basis of comparison when an adverse stimulus should be administered.

Orthogonally placed three antennas on the collar/receiver was disclosed in U.S. Pat. No. 5,067,441 to Weinstein. It allowed for good reception and the calculation of the square root sum of the squares signal strength from the three antennas also provided solid signal strength determination allowing for the stimuli being administered properly so it could be learned by the animal.

U.S. Pat. Nos. 5,161,485 and 5,207,178 contributed to the reliability of the stimuli being given at a prescribed level and at the proper time. In U.S. Pat. No. 5,207,178 a flexible connector allowed a good connection to allow the receiver/collar to do just that without regard to the animal's continual movements. U.S. Pat. No. 5,161,485 made the collar and electrodes insulated to reduce the wear on the electrodes and to overcome the wet environment problem of a dog's coat through play or inclement weather.

U.S. Pat. No. 5,170,172 was able to make cost effective and reliable a technology for measuring electromagnetic waves that previously had not been done. This allowed the receiver to be lighter weight and more cost effective while still being very reliable.

U.S. Pat. No. 5,207,179 discloses a transmitter that monitors the integrity of the antennal loop and provide a temporary battery back up in the event that antenna loop/circuit was broken. A further advance was the collar's ability to accept owner's recorded voice commands to be used in conjunction with deterrent stimuli application.

From 1993 to 1995 two advances relating to radio waves occurred. The need for a transmitting of waves that could not confuse the receiver, would not be obstructed by metallic interference and structures, and were not as power hungry as the previous art was required. Signals were being confused by other waves ever present in the outside environment and were causing underserved shocks to the pet population using these pet containment devices.

U.S. Pat. No. 5,353,744 to Custer encoded the waves so as to distinguish them from outside interference. Custer's next patent, U.S. Pat. No. 5,465,687 took those coded waves and accomplished a burst transmission to lower the power requirements while further distinguishing the waves for its receiver/collar to recognize accurately with little confusion.

Grimsley's U.S. Pat. No. 5,460,124 encoded an AM signal for recognition purposes and combined it with microprocessors that were designed to shut down non-essential functions of the receiver to save power. It then decided to modulate the low frequency AM waves combined with more micro processing battery saving functions in U.S. Pat. No. 5,682,839.

U.S. Pat. No. 5,575,242 to Davis introduced low frequency FM waves which by their nature are relatively interference free compared to their other counterparts and are transmitted with much less power.

U.S. Pat. No. 5,559,498 to Westrick combined two traditionally separate apparatus into one. Pet containment and a pet training apparatus which were usually mutually exclusive.

### SUMMARY OF THE INVENTION

An object of the present invention is to keep roofers working on a low slope (less than 2/12 pitch) roof in the safe area that they are intended to be located and to alert them when they stray from that area and put themselves in danger of a fall from the unprotected roofs edge. In accordance with one embodiment of the invention when it is desired, for example, to prevent a roof worker from moving into or out of a predetermined area, a safe zone if you will, an electrical antenna in the form of a wire is placed at or on the roof area at the roof's edge to surround the roof work area, to radiate a field in the vicinity of the wire when energized such as by an A.C. current alternating at a sub-broadcast band frequency. A receiver circuit may be incorporated in an article such as a hard hat, and/or wristband to be worn by the roofer so as to receive signals from the wire when the roof worker approaches the wire. The receiver circuit, which may produce an intermittent auditory high pitched tone such as a beep, which has been taught to the roof worker that when heard that he is outside of the safe area and has transgressed within the fall danger zone (FDZ) is given. The area that comprises the FDZ is the unprotected roof edge to the ten foot mark back and parallel from the perimeter of the roofs edge that is considered an unprotected edge and a fall hazard by OSHA. The area interior of the FDZ is deemed a safe zone to conduct work without fall protection and motion stopping safety equipment. The boundary of the safe zone and FDZ (typically a ten foot or six foot setback from the roofs unprotected edge depending on whether mechanized equipment is being used) has requirements promulgated by OSHA; a standard 19260501b10 that this apparatus is attempting to meet in a different manner/method.

The receiver circuit is of the low power, high voltage type preferably energized by a dry cell battery. The receiver circuit further includes an antenna for picking up the signals radiated from the wire, an amplifier for amplifying the signal, and an oscillator circuit for operating the alarm means which may either be a loud speaker or a coil for producing a warning tone to the roof worker and in some cases an aversive shock. The receiver circuit further includes an energy storing circuit for powering the oscillator means. The antenna is tuned to the frequency of the signal radiated from the wire.

In use, the receiving unit may be placed in a wristband and/or in or on a hard hat with the conductor positioned so as to make contact with the skin of the worker (if the wrist band) or close to the roof worker's ear (if the hard hat). When the roofer inadvertently approaches the signal emitting wire, the tuned antenna on the hard hat will pick up the signal and feed it to the voltage amplifier of the receiver circuit. The strength of the signal fed to the amplifier will vary with the proximity of the worker to the signal radiating wire. At the fringes of the signal field, the voltage will be small, and the amplified voltage applied to the D.C. energy storing circuit may be of low magnitude.

At reduced voltage, the oscillator may cause an induction coil, associated with the conductor, to produce an auditory signal to the roof worker. The shrillness of the auditory beep will increase as will the time between beeps decreases (become less intermittent) as the roof worker gets closer to the signal radiating wire which not coincidentally is also closer to the unprotected roofs edge where a fall hazard is greatest. When the roofer strays to within three foot of the roofs edge a shock or uncomfortable vibration will be delivered to the worker through the wristband. However, the lower power characteristics of the circuit will never allow the shock to be hazardous to the worker.

If the roofer is positioned in the area enclosed by the signal radiating wire, the warning tones and possible shock produced on the worker may remind the roofer that he is close to the unprotected roofs edge where a fall could occur. The worker distracted by his work tasks is alerted to the danger of a fall by the learned warning tones and the shock/vibration (when the worker is dangerously close to the edge within three feet) when given. By OSHA standards, the roof worker is required to use another set of procedures when that worker is working in the fall danger zone (FDZ). One of the preferred procedures is for a non-working safety monitor whose job is to keep in close sight and proximity with roofers when the roofers by intent are working in the FDZ so they can be verbally warned.

The advantages of this invention are many. It is simple and easy to install and is designed to use low power transmitters and receivers. This system has lightweight components and may be attached to any objects moveable or stationary and is typically battery operated. It may be used with multiple transmitters and multiple receivers and may be used to warn the roofers when they are in the fall danger zone (FDZ) and close to the unprotected roofs edge. The system is less subject to interference from noise components because of its operating frequency and its high frequency deviation.

### BRIEF DESCRIPTION OF THE DRAWINGS

FIG. 1 shows a view from above orthogonally of a representative low slope (less than 2/12 pitch) roof.

FIG. 2 shows the components of the fall protection apparatus.

FIG. 3 shows a portion of the same roof in FIG. 1. It is a corner view or cross section of the roof.

FIG. 4 is the same picture of the roof as FIG. 3 except it has three roof workers in the figure. The location of the roof workers will show the fall protection apparatus performing its design function.

FIG. 5 shows two separate methodologies for one PPE receiver.

FIG. 6 shows an alternate embodiment of the fall protection system of the present invention.

### DETAILED DESCRIPTION OF THE INVENTION

The following detailed description is of the best currently contemplated modes of carrying out exemplary embodiments of the invention. There is no limiting sense of this invention when it is considered for use within the parameters of the roofer performing low slope roofing, but is made merely for the purpose of illustrating the general principles of the invention, since the scope of the invention is best defined by the appended claims.

Broadly, an embodiment of the present invention generally may provide a fall protection for roofers 36 working on low slope roofs 18 (less than 2/12 pitch). More specifically, a coated wire or cable 14 may be strung around a perimeter edge of the work area. The wire 14 is laid in such a continuous manner that a loop or circuit is formed. Completing the loop is a modified transmitter 12. The transmitter 12 completes the loop by connecting both ends of the coated wire 14 to the modified transmitter 12. Electromagnetic or radio waves 38 (AM type) may be transmitted from this modified transmitter 12 through the wire 14 also referred to as antenna wire.

A battery 10 that powers the transmitter 12 that produces the radio waves 38 or radio frequency (RF). The battery 10 can be replaced by a hard wired connection to the building's electrical system. The battery 10 can also be replaced by a portable electrical generator as a source of power. In some cases the battery 10 may be replaced by the transmitter 12 which has portable batteries for self powering.

The transmitter 12 produces the electromagnetic, FM and/or AM radio waves 38 at a low frequency level. The transmitter 12 may encode them, modulate the waves, and issue them in pulses to both save energy and make those RF differentiated from other omnipresent RF out in the environment. The transmitter 12 may also have a lightening arrestor included to protect the apparatus. The transmitter 12 may have a storage area for data that it stores when one of the receivers issues a warning. The date, time and receiver number of the warning are transmitted from the receiver to the transmitter 12 for storage. That information is readily transferred to a specialized smart phone app that downloads the information to the phone which sends it out to the supervising entity.

An antenna wire 14 is affixed to one outgoing terminal of the transmitter 12. The antenna wire 14 is run in one continuous length around the perimeter edge of the roof 18. The other end of the antenna wire 14 is connected to the incoming terminal of the transmitter 12. This connection completes the circuit and loop that establishes perimeter protection for the roofer while he is working on a specific roof 18.

Metal clips 16 hold the antenna wire 14 at a perimeter edge of the roof. They typically will be installed every five to ten feet on center to establish the integrity of the safety system. The clips 16 keep the antenna wire 14 in the correct position at the edge of the roof 18. The fasteners and wire clips 16 for the antenna wire 14 may hold the wire 14 in place while the roofing project is being installed. The fasteners 16 may hold the wire 14 in its installed position at the edge of the roof 18.

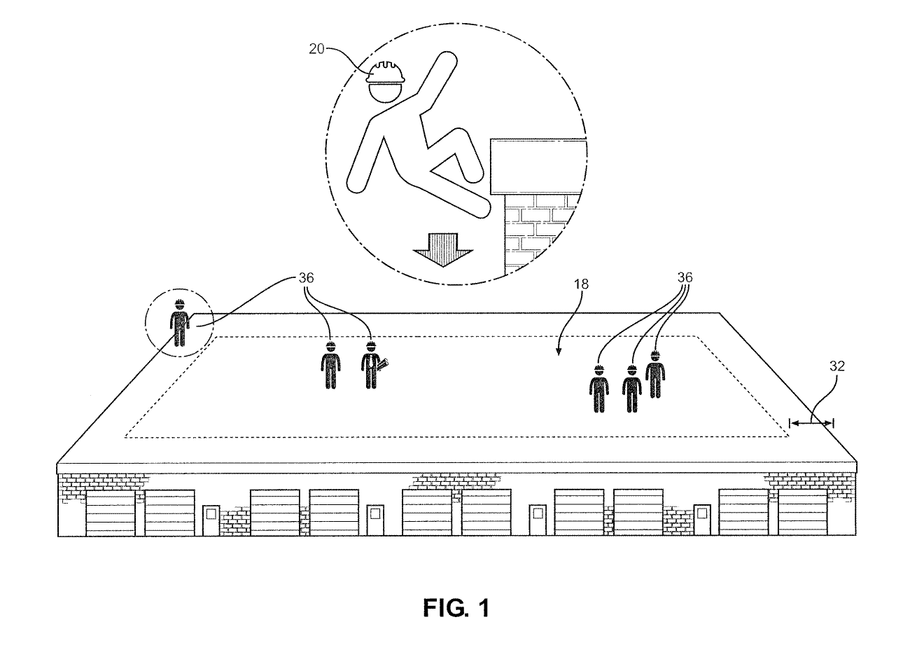

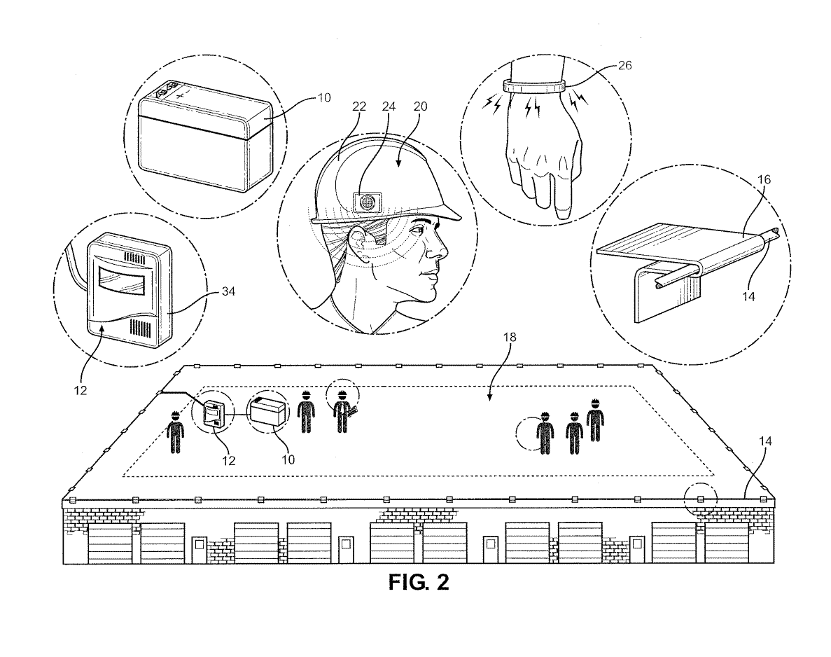

The elevation as shown in FIG. 1 portrays the safety hazard which is a potential fall when roofing crews are doing work on the building. The top left corner shows a shadow figure representative of a roof worker 36 at the onset of a fall from the unprotected edge of the roof 18. The unprotected edge is the main safety hazard of roof workers 36. The area in the middle of the roof 18 is a safe working area, as deemed by OSHA, in that it is either six feet set back but most probably ten feet set back when mechanical equipment is used, back from the roofs unprotected edge. This is delineated by the dashed line. The area outside of the dashed line is the area that requires a separate set of fall protection guidelines as promulgated by OSHA. This area for the purposes of this application is the fall danger zone (FDZ) 32. The safety requirements of OSHA when working in the fall danger zone 32 are not considered here. The object of the invention is to keep the roof workers in the safe work area and warn the roof workers when they stray either purposely or inadvertently into the FDZ 32. The edge of the roof 18 is where there is danger of workers 36 falling. The edge of the roof 18 is fall danger to the roof worker 36 and is commonly referred to in safety circles as the unprotected edge. The edge of the roof 18, unless it is above forty two inches high from roof level, is considered an unprotected edge and a fall danger to roof workers 36 by most agencies around the world including OSHA. The installation of the antenna wire 14 at the outer perimeter of the roof 18 with the broadcasting transmitter 12 may allow the system to set up a safe working area for the roof workers 36. The modified transmitter 12 has to have power to accomplish this by broadcasting its signal. There may be on average five hundred lineal feet of antenna wire 14 to broadcast the signal 38 thru the antenna wire 14 on the average roof project. The modified transmitter 12 may have its own battery pack to provide the power to accomplish this task of broadcasting. The modified transmitter 12 may be hard wired to the building existing electrical system as another means of powering the modified transmitter 12. The modified transmitter 12 may use an external battery 10 or a powered generator as other sources of power from which to broadcast its signal 38 through the antenna wire circuit or loop 14. The modified transmitter 12 broadcasting its signal 38 with its circuit or loop of antenna wire 14 is what defines all fall danger zone (FDZ) 32. One of the several selected setting of the modified transmitter 12 may establish both an approved FCC frequency and a specific power setting. Combined the frequency and power setting will establish the fall danger zone (FDZ) 32. This is the area that it is unsafe for the roof worker 36 to be without a non-working human safety monitor observing him to ensure that his work does not put him in danger of falling off from the roofs edge. The roof worker 36 is allowed to work unsupervised as long as that worker is at least ten feet from the roofs edge by current OSHA safety standards. The settings on the modified transmitter 12 each establish a FDZ 32 a specific distance from the roofs edge. Each setting of the broadcasting transmitter 12 complies with the safety requirements of OSHA given specific conditions. The compliance with OSHA's specific safety requirements is accomplished by a signal strength of the broadcasting transmitter 12 being translated into specific distances from the roofs edge where the danger of falls is most prevalent. The specific distances established are either six or ten feet from the roof's edge. The transmitter 12 allows for a choice between establishing a fall danger zone either six or ten feet from the roofs edge. Where the antenna wire 14 is the conduit for the broadcasting transmitter 12 establishes the fall danger zone (FDZ) 32. The width of the zone will either be six or ten feet back from the roofs edge depending on the setting selected.

The transmitter 12 may send the radio waves 38 through the cable or wire 14 activating the fall protection system. The waves 38 may be produced at a specific range that other components may receive, such as but not limited to an A.C. current alternating at a sub-broadcast band frequency or from approximately 60 Hz. The transmitter 12 may be in a waterproof durable case 34 to protect it from the elements and the roof installation process. The transmitter 12 may have an alarm that may notify the crew if power is lost or interrupted. The transmitter 12 may receive its electrical power from a battery 10, a generator, the building's existing power supply or from batteries within the unit itself. The transmitter 12 may have circuits which create and transmit through the antenna wire 14, predetermined frequencies, frequency modulations, amplitude modulations, random and non-random codes within the radio waves, electromagnetic modulations, and/or pulse transmissions.

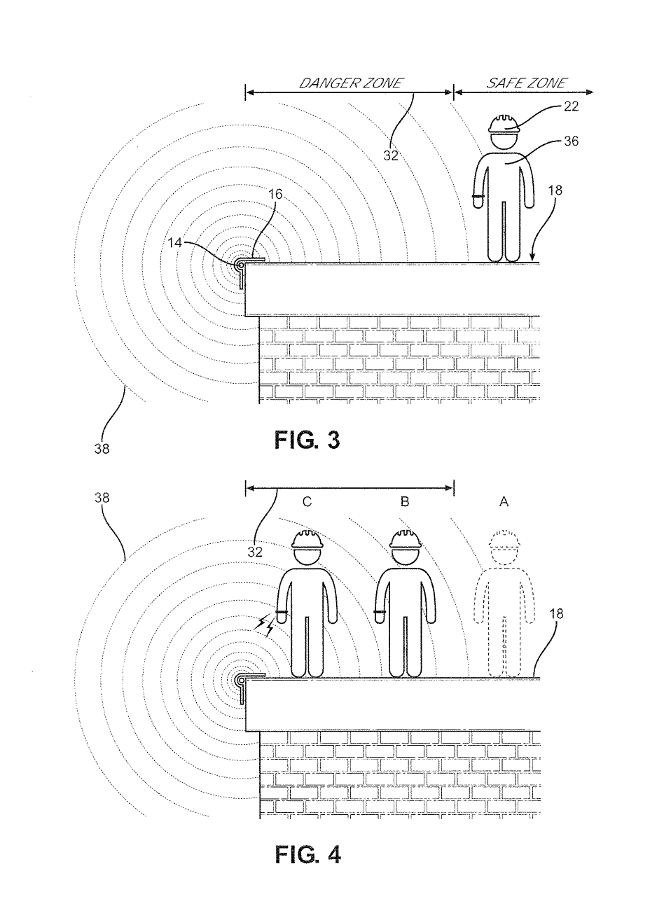

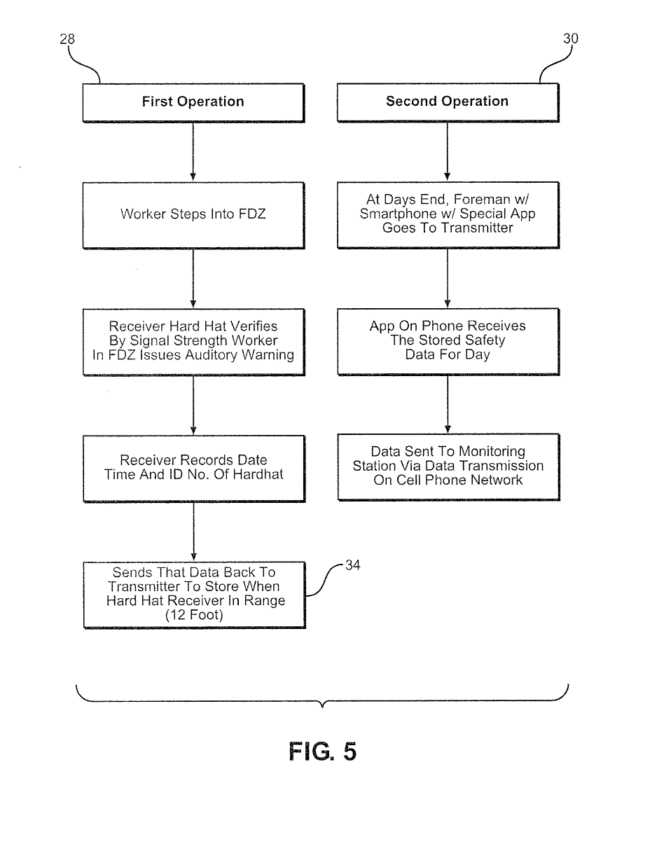

The vertical dotted line shown in FIG. 3 is a ten foot set back. The OSHA required set back is the demarcation between what is considered a safe area to perform roof work without fall arrest equipment termed the safe zone and the area where there is danger of a fall occurring if that worker is not wearing fall arrest equipment, termed the fall danger zone (FDZ) 32. At the edge of the roof 18 the antenna wire 14 is shown to be held in place at the roofs edge by a metal clip 16. The operational antenna 14 is broadcasting its signal through radio waves represented by the drawing. The roof worker is in the safe zone and is wearing both pieces of personal protective equipment (PPE), the PPE hardhat receiver 20 and the PPE wristband receiver 26.

A first personal protective equipment (PPE) receiver 20 which is a hard hat 22 with a receiver 24 mounted to the exterior or interior of the hard hat 20. That PPE receiver 20 may instantly and continuously process the signal strength of the broadcast antenna. The PPE receiver 20 may equate the signal strength to a distance from the roofs edge where the antenna 14 and transmitter 12 are broadcasting from. The receiver 24 is set to warn the roofer when he is close to a specific distance or setback from the roofs unprotected edge. The PPE hard hat 22 has two settings, one a six foot setback limit and the other a ten foot setback limit. The worker 36 when he inadvertently encroaches to the limit or past it may have the receiver issue an auditory warning that the worker 36 has been trained to recognize. The warnings are intermittent beeps that get louder and shriller and less intermittent the closer that roofer 36 strays to the roofs unprotected edge. This warning reminds the worker of the hazardous position he is in thereby preventing an inadvertent fall.

A second personal protective equipment (PPE) receiver 26 which is a wristband that has a receiver mounted within. The second PPE receiver 26 may instantly and continuously process the signal strength of the transmitter 12 broadcast. It may equate the signal strength to a distance from the roofs edge where the antenna 14 and transmitter 12 are broadcasting from. The receiver 26 is set to warn the roofer when he is close to a specific distance or setback from the roofs unprotected edge. The second PPE wristband 26 has no adjustable settings. It is programmed to issue its warning when the wearer is within three feet of the roofs unprotected edge. Its warning is an uncomfortable vibration or an electrical adverse stimulus to warn the roof worker of a potential fall due to his close location to the roofs edge.

The PPE 20, 26 may have a receiver 24 designed to pick up the transmitted radio waves 38 at a specific frequency from the transmitter 12. The receiver 24 may calculate the distance the PPE 20, 26 is from the wire 14 transmitting these specific radio frequencies. The calculations may be on the basis of the strength of the received signal 38. A preset distance of a number of feet, yards or meters may activate the received warning. In the case of the hard hat PPE 20, an auditory warning may issue. In the case of a wrist band system 26, a sensory warning may be emitted via vibration or electrical warning. Receipts of these pre-learned warnings may inform the worker 36 that he or she is at or in the fall danger zone 32. So informed the roof worker 36 may take precautions to avert the hazard by retreating to the safe area. An accidental fall may be averted.

Included elements in this invention may be considered an improvement. Housed within the transmitter 12 may be a data collection center 34 for each PPE 20, 26 being used at the time. The data collection center 34 may track the time when the individual PPE 20, 26 is turned on and tested for its fall protection reliability. Incursions into the fall danger zone (FDZ) 32 or hazard zone may be recorded by the time the date and by the individual PPE device 20, 26. The transmitter 12 may use an app downloaded to a smart phone. From the smart phone the information for that day's work may be sent to the employer, the insurer of the employer and/or OSHA. This may allow the data to be compiled and monitored so the safety of the roofing operation and each individual worker 36 may be evaluated. The employer of the worker, insurer of the company employing the worker 36 and OSHA could monitor that day's data. The PPE 20,26 may be modified so that worker 36 resistance to wearing the PPE 20,26 would be virtually impossible as the PPE 20,26 may be able to determine if a human is actually wearing the particular PPE 20,26.

A typical low slope roof crew would vary between five and fifteen roof workers 36. Each roof worker would wear at least one possibly two PPE receivers 20, 26. Each receiver may perform a recording function as described and will send the data to the broadcasting transmitter 12. The broadcasting transmitter 12 may store that data. The first operation 28 of the methodology exhibits how one incursion to the FDZ is recorded for that one roof worker. The data of the incursion is captured and preserved by its being sent to the broadcasting transmitter 12. The second operation 30 has the roof supervisor at the end of the day using a smart phone to collect that information from the broadcasting transmitter 12 and sending it to the supervising entity.

In operation, the boundaries of the roof area are put in place by the installation of the antenna wire 14 or cable. The antenna wire 14 may be held in temporary or permanent place by the fasteners 16. The antenna wire 14 may be hooked up to a transmitter 12 which sends a specific set of radio waves 38 through the antenna wire 14. The antenna wire 14 may emit the radio waves 38 once an outside power source is established. The roof installers may wear the PPE hard hat receiver 20 and/or a PPE wrist band receiver 26. The PPE 20, 26 may pick up a transmitted frequency and continually calculate where the wearer of this equipment is in relationship to the edge of the roof 18. When the wearer is within a fixed (or variable) distance of the edge, a warning is issued either auditory and/or sensory. This may tell the roof installer 36 that he or she is in or approaching the hazard or fall danger zone 32.

As shown in FIG. 1, roof worker A is twelve feet from the perimeter of the roofs edge. Roof worker A is in no danger of a fall yet. Roof worker A is close, within two feet of being in what OSHA considers to be at risk of a fall occurring. For now, roof worker A is safe, but that could change momentarily. The PPE hard hat receiver 24 processes the signal from the broadcasting antenna 14 and verifies that roof worker A is twelve feet from the roofs edge. A lazy intermittent soft low pitch auditory warning is issued by the PPE hardhat receiver 24 to roof worker A every two to three seconds. By previous training roof worker A is aware that he is safe from a fall, but he is close to the area where he will not be safe. The reminder to roof worker A about his approximate location is received and understood in case that roof worker was preoccupied with the job at hand or forgot his relative location to the roofs edge. The PPE hardhat receiver 24 does not record this event as there was no incursion into the FDZ 32.

Also shown in FIG. 4, roof worker B is in the fall danger zone from six to less than ten feet away from the roofs edge. The PPE hardhat receiver 24 has processed the signal strength from the broadcasting antenna 14 and has calculated and verified instantaneously that roof worker B is in the fall danger zone (FDZ) 32 and is six to less than ten feet away from roofs edge. The PPE hardhat receiver 24 issues an auditory warning beep every one second which is louder and more shrill due to roof worker B being in relative danger of having a fall occur. Roof worker B by training knows he is in the fall danger zone 32 if he did not before and is closer to the edge than he should be. If roof worker B was unaware he has been reminded and roof worker B should retreat to a safer distance or don proper fall arresting equipment. The PPE hardhat receiver 24 records this event as there was an incursion into the FDZ 32.

As shown in FIG. 4, roof worker C is less than three feet away from the roofs edge and is in the FDZ 32. The PPE hardhat 20 has processed and verified location and is giving roof worker C a near continuous loud shrill auditory warning. His training makes roof worker C aware that the threat of a fall is real and imminent. To further reinforce the seriousness of the potential fall the PPE wristband receiver 26 which has performed the same calculations and verified the close distance to a fall issues it warning. The PPE wristband receiver 26 issues a mild electrical shock and/or an uncomfortable vibration. Roof worker C due to his training is aware that a fall could occur and retreats to the safe area or puts on fall arrest equipment. The PPE hardhat receiver 24 records this event as there was an incursion into the FDZ. The PPE wristband receiver 26 records this event as there was an incursion into the FDZ.

The emitted signal 38 may be measured by the receiver 20, 26 also called the Personal Protective Equipment or PPE. The intensity level of the signal 38 may be the threshold that trips or begins the warning, which is usually first an auditory or sensory warning. The antenna wire 14 establishes the area. The transmitter 12 may activate the warning system. The receiver 20, 26 may determine when the wearer's movements have placed him within ten feet of the building's edge. That area may be the hazard zone or the fall danger zone 32. The wearer may be warned. The system may be assembled by configuring the wire or cable 14 to the shape size and boundaries edge of the roof 18. The clips 16 used may be based on the type of edge to hold the wire 14 in place for the duration of the roofing project and keep the integrity of the perimeter. The transmitter 12 may be connected to the cable or wire 14. The transmitter 12 may be connected to a power source 10, either the buildings power or a generator.

Each worker should wear an auditory receiver and a sensory receiver. The receivers 20, 26 may be set on the same frequency as the transmitter 12. The auditory and sensory receiver should have a preset threshold where signal strength corresponds to one of two set specific distances either six or ten feet. In this described case, ten feet in from the wire or cable 14 is the described distance. The threshold has to be calibrated exactly to achieve the proper distance and signal strength. Once the threshold is reached the receivers 20, 26 should trigger the warning. The intensity of the auditory warnings and sensory warnings will increase after the initial warning if the wearer of this PPE 20, 26 does not heed the warnings and retreat to a distance greater than the threshold settings of ten or six feet. The auditory warnings will become louder, more shrill and less intermittent the closer to the roof's edge the wearer of this PPE 20, 26 is.

In the case of the receiver wristband PPE 26 an uncomfortable vibration distinctive to be felt should be given to the wearer of the wristband and/or a mild electrical shock. This may occur when the signal intensity is such that the roof worker 36 is at or within three feet of the roofs unprotected edge.

The same is true of the auditory hardhat 20. The warning, depending on the culture may issue a verbal order in a particular language to stop moving. Alternatively, it could be a warning signal. The warning signal may be intermittent and lower tone when the roof worker is twelve feet back from the perimeter which is just two feet from the FDZ 32. The warning may remind the roofer 36 that he is close to the FDZ 32. If the roofer 36 strays into the FDZ 32 the beeps may get less intermittent and louder and more shrill the longer and/or closer that roof worker 36 gets to the root's unprotected edge.

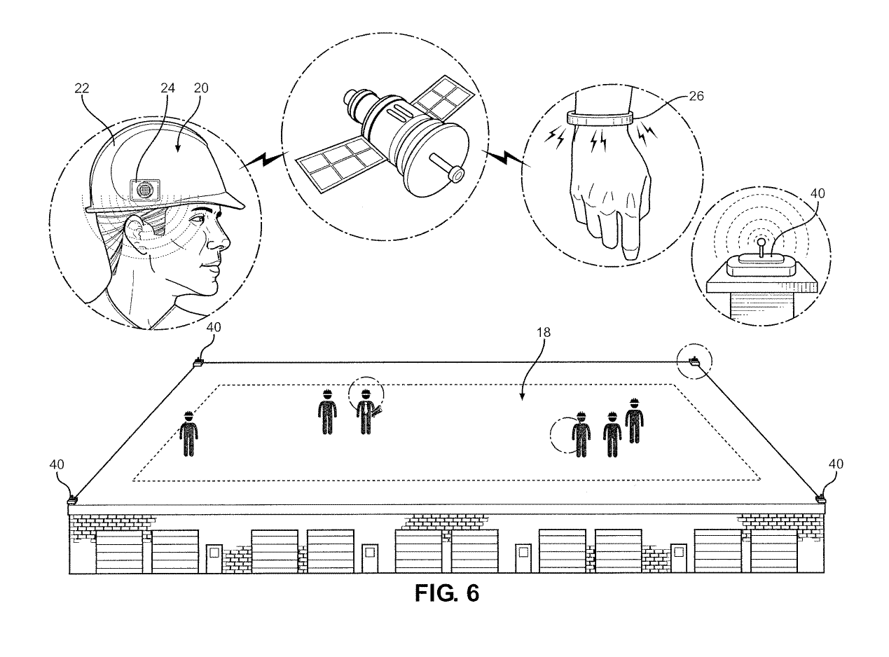

The system may be reconfigured, as shown in FIG. 6, using GPS in real time as the calculation time and error function are reduced. Multiple GPS locaters 40 may be arranged at all corners of the roof's edge and at a midpoint acting as satellites but defining the outer perimeter of the roofs perimeter, the PPE equipment 20, 26 may be transmitters to the satellites and may determine when the roof worker 36 wearing a PPE 20, 26 is within six or ten feet of the roof's perimeter thereby actuating an alarm/warning protecting that worker 36 from a potential fall and preventing injury and death by stopping an outcome that may occur soon. The GPS may have to be more accurate and quicker in reporting calculated distances. Once the multiple GPS locaters 40 are in place, their location can be determined. A triangulation of these locaters 40 with the PPE hardhat 20 may allow an exact accurate location to the edge of the roof 18.

It should be understood that the foregoing relates to exemplary embodiments of the invention and that modifications may be made without departing from the spirit and scope of the invention as set forth in the following claims. The foregoing relates specifically to working on a low sloped roof (less than 2/12 pitch).

What is claimed is:

1. A fall protection system for roof workers working on low-slope roofs, said system comprising:
(a) an antenna, said antenna attached at an edge of the roof to be worked on by a plurality of roof workers;
(b) a transmitter in communication with said antenna;
(c) a personal protective equipment receiver;
(d) both ends of said antenna attached to said transmitter, forming a loop or circuit at an outside edge of the roof;
(e) a power source electrically connected to said transmitter, said transmitter sends broadcast waves through said antenna inward from said edge of the roof defining a fall danger zone for the roof work;
(f) said personal protective equipment receiver is worn by the roof workers and receive individually said waves transmitted from said antenna;
(g) said personal protective equipment receiver evaluates a signal strength from said transmitter and said antenna and determine if the roofer wearing said personal protective equipment receiver is in danger of a fall by being approximately ten feet or less from the roofs unprotective edge; and
(h) said personal protective equipment receiver does not activate and issue any auditory warning or physical stimulus warning when the roofer is beyond approximately twelve feet from the roof's edge.

2. The fall protection system of claim 1 wherein said personal protective equipment receiver activates and issues said auditory warning consisting of an intermittent beep every two to three seconds that is of low pitch and low loudness when the roofer is at less than approximately twelve feet to approximately ten feet from the roof's unprotective edge.

3. The fall protection system of claim 1 wherein said personal protective equipment receiver activates and issues said auditory warning consisting of an intermittent approximately one beep every one to two seconds that is of higher pitch and louder when the roofer is between approximately one foot and three feet from the roof's unprotective edge and the fall danger is real.

4. The fall protection system of claim 1 wherein said personal protective equipment receiver activates and issues both said auditory warning consisting of an intermittent beep approximately one half to one second that is of highest pitch and loudest, in addition said physical stimulus warning is issued in the form of an electrical shock and or an uncomfortable vibration when the roofers are approximately three feet from the roof's unprotective edge and the fall danger is real and a fall could be imminent.

5. The fall protection system of claim 1 wherein said personal protective equipment receiver protects the roofers from falls by informing the roofers when the roofers are close to the fall danger zone but not yet in the fall danger zone, thereby warning the roofers of their location, should the roofers have forgotten their location and warning the roofers to stay out of the fall danger zone and that they are close to the fall danger zone; and
when the roofers are in the fall danger zone either on purpose or inadvertently said personal protective equipment receiver warns the roofers with an auditory warning that becomes louder and more shrill and less intermittent the closer the roofers are to the roofs edge, until the roofers who are within approximately three feet of the roofs edge are given the physical stimulus warning which tells the roofers that the roofers are in imminent danger of a fall.

6. The fall protection system of claim 1 wherein said transmitter having a wire carrying an A.C. current alternating at a sub-broadcast band frequency approximately from 60 Hz.

7. The fall protection system of claim 1 wherein said transmitter having circuitry for developing and transmitting a signal through said antenna wire.

8. The fall protection system of claim 1 further comprises a monitoring unit for monitoring failures and potential failures of said loop antenna having a break therein, a low battery, and power failure, said monitoring unit actuates an audible alarm warning if said failure is detected.

9. The fall protection system of claim 1 further comprises a lightening arresting protection unit.

10. The fall protection system of claim 1 wherein said personal protective equipment receiver having three receiving antennas being generally orthogonally positioned; and
switch receiver circuitry coupled to said three receiving antennas and selectively coupling, one at a time, ensuring if a signal strength of said antenna is available the said three receiving antenna pick up the signal regardless of the position of said personal protective equipment receiver on the worker wearing said personal protective equipment receiver.

11. The fall protection system of claim 1 wherein said personal protective equipment receivers having a microprocessor, said microprocessor having a receiver switch circuitry, signal strength circuitry, code detection circuitry, and motion sensor circuitry which cycles off and on at predetermined times to conserve energy.

12. A fall protection system for roof workers working on low slope roofs, said system comprising:
(a) a transmitter;
(b) a personal protective equipment receiver;
(c) a smart phone with an application;
(d) said personal protective equipment receiver gives auditory and physical stimuli warnings when a roofer is approximately twelve feet or less from the roofs unprotective edge where a fall could occur;
(e) after said personal protective equipment receiver issues a warning to the roofer
wearing said personal protective receiver, said transmitter stores the date, time and a personal protective equipment receiver identification number;
(f) at an end of a workday a foreman of the roof workers uses said smart phone and said application to link with said transmitter and retrieve all the data from all of the roof workers said personal protective equipment receivers;
(g) said smart phone sends said retrieved data to supervising and/or monitoring authorities;
(h) the supervising and/or monitoring authorities are an employer, an insurer for the employer and/or OSHA;
(i) with the data, the monitoring authorities analyze the performance of the plurality of roofers work from a safety perspective after a benchmark is established;
(j) the supervisor evaluates overall safety performance of the plurality of the roofers as a whole and evaluates the safety performance of the individual roofer through said personal protective equipment receiver/identification number which may correspond to the individual roofer;
(k) if the roof workers overall safety performance is below acceptable levels, the supervisor is informed and corrective action is taken; and
(j) if one roofer is identified for poor safety performance, the supervisor is informed and takes corrective action to avert a future fall.

13. A fall protection system for roof workers working on low slope roofs, said system comprising:
multiple GPS locaters arranged at all corners of a roofs edge and at a midpoint thereof, said locaters define an outer perimeter of the roof;
a personal protection equipment receiver in communication with said locaters; and
said personal protection equipment receiver transmits to said locaters and determines when the roof worker is within six or ten feet of the roofs perimeter, thereby actuating an alarm/warning to protect the worker from a potential fall.
